(19) United States
(12) Patent Application Publication
(10) Pub. No.: US 2023/0032430 A1
(43) Pub. Date: Feb. 2, 2023

(54) SOLENOID, DAMPING FORCE ADJUSTMENT MECHANISM, AND DAMPING FORCE ADJUSTABLE SHOCK ABSORBER

(71) Applicant: Hitachi Astemo, Ltd., Ibaraki (JP)

(72) Inventors: Shunsuke MORI, Hitachinaka-shi, Ibaraki (JP); Takashi NEZU, Hitachinaka-shi, Ibaraki (JP)

(21) Appl. No.: 17/783,773

(22) PCT Filed: Dec. 10, 2020
(86) PCT No.: PCT/JP2020/045995

§ 371 Date: Jun. 9, 2022

(30) Foreign Application Priority Data
Dec. 12, 2019 (JP) 2019-224682

(51) Int. Cl. F16F 9/36; F16F 9/50; H01F 7/08

(52) U.S. Cl. CPC F16F 9/369; F16F 9/50; H01F 7/081; F16F 2222/12; F16F 2230/30; F16F 2228/066; F16F 2230/18; B60G 13/08

(57) ABSTRACT

A molded coil includes a bobbin, a coil, and an exterior member. The coil is wound around the bobbin, and generates a magnetic force in reaction to power supply. The exterior member covers the coil and the bobbin therewith. Two seams, a first seam and a second seam are provided between the bobbin and the exterior member. A first seal member is disposed on an upstream side of the first seam and between a cover member and the exterior member. A second seal member is disposed on an upstream side of the second scam and between a flange portion of a stator core main body and the exterior member.

### TECHNICAL FIELD

The present disclosure relates to, for example, a solenoid, a damping force adjustment mechanism, and a damping force adjustable shock absorber.

### BACKGROUND ART

For example, vehicles such as four-wheeled automobiles are equipped with shock absorbers (dampers) between the vehicle body (sprung) side and each wheel (unsprung) side. One known example of such shock absorbers of vehicles is a damping force adjustable hydraulic shock absorber that variably adjusts the damping force according to the running condition, the behavior of the vehicle, and/or the like. The damping force adjustable hydraulic shock absorber forms, for example, a semi-active type suspension of the vehicle. The damping force adjustable hydraulic shock absorber can variably adjust the damping force to generate by adjusting the valve-opening pressure of a damping force adjustment valve using a damping force variable actuator. PTL 1 discusses a solenoid used for the damping force variable actuator.

### CITATION LIST

### Patent Literature

PTL 1: Japanese Patent Application Public Disclosure No. 2014-11352 (Japanese Patent No. 6084787)

### SUMMARY OF INVENTION

### Technical Problem

The solenoid includes a coil that generates a magnetic force in reaction to power supply. Then, for example, suppose that the solenoid has such a configuration that the coil and a bobbin with the coil wound around it are covered with an exterior member made from synthetic resin by molding. In the case of such a configuration, the entry of water into a seam between the bobbin and the exterior member from outside is undesirable.

### Solution to Problem

An object of one aspect of the present invention is to provide a solenoid, a damping force adjustment mechanism, and a damping force adjustable shock absorber capable of improving a sealing performance for a seam between a bobbin and an exterior member.

According to one aspect of the present invention, a solenoid includes a coil wound around a bobbin and configured to generate a magnetic force in reaction to power supply, an exterior member covering the coil and the bobbin therewith, a movable element disposed on an inner peripheral side of the coil and provided axially movably, a housing member housing the movable element therein, a stator configured to attract the movable element, a control valve configured to be controlled according to a movement of the movable element, a first member disposed on one axial end side of the exterior member, a second member located on an opposite axial end side where an opposite axial end of the exterior member is located and the control valve is disposed, and a third member covering a radially outer peripheral side of the exterior member therewith. A first seam and a second seam are provided between the bobbin and the exterior member. A first seal member is disposed on an upstream side of the first seam and between the first member and the exterior member. A second seal member is disposed on an upstream side of the second seam and between the second member and the exterior member.

Further, according to one aspect of the present invention, a damping force adjustment mechanism includes a coil wound around a bobbin and configured to generate a magnetic force in reaction to power supply, an exterior member covering the coil and the bobbin therewith, a movable element disposed on an inner peripheral side of the coil and provided axially movably, a housing member housing the movable element therein, a stator configured to attract the movable element, a control valve configured to be controlled according to a movement of the movable element, a first member disposed on one axial end side of the exterior member, a second member located on an opposite axial end side where an opposite axial end of the exterior member is located and the control valve is disposed, and a third member covering a radially outer peripheral side of the exterior member therewith. A first seam and a second seam are provided between the bobbin and the exterior member. A first seal member is disposed on an upstream side of the first seam and between the first member and the exterior member. A second seal member is disposed on an upstream side of the second seam and between the second member and the exterior member.

Further, according to one aspect of the present invention, a damping force adjustable shock absorber includes a cylinder sealingly containing hydraulic fluid therein, a piston provided slidably in the cylinder, a piston rod coupled with the piston and extending out of the cylinder, and a damping force adjustment mechanism configured to generate a damping force by controlling a flow of the hydraulic fluid that is generated according to a sliding movement of the piston in the cylinder. The damping force adjustment mechanism includes a coil wound around a bobbin and configured to generate a magnetic force in reaction to power supply, an exterior member covering the coil and the bobbin therewith, a movable element disposed on an inner peripheral side of the coil and provided axially movably, a housing member housing the movable element therein, a stator configured to attract the movable element, a control valve configured to be controlled according to a movement of the movable element, a first member disposed on one axial end side of the exterior member, a second member located on an opposite axial end side where an opposite axial end of the exterior member is located and the control valve is disposed, and a third member covering a radially outer peripheral side of the exterior member therewith. A first seam and a second seam are provided between the bobbin and the exterior member. A first seal member is disposed on an upstream side of the first seam and between the first member and the exterior member. A second seal member is disposed on an upstream side of the second seam and between the second member and the exterior member.

According to the one aspect of the present invention, the sealing performance for the seam between the bobbin and the exterior member can be improved.

### BRIEF DESCRIPTION OF DRAWINGS

FIG. 1 is a vertical cross-sectional view illustrating a damping force adjustable shock absorber in which a solenoid and a damping force adjustment mechanism according to a first embodiment are built.

FIG. 2 is an enlarged cross-sectional view extracting and illustrating a damping force adjustment valve and the solenoid illustrated in FIG. 1.

FIG. 3 is an enlarged cross-sectional view illustrating a portion III illustrated in FIG. 2 with the right side thereof placed on the upper side.

FIG. 4 is an enlarged cross-sectional view illustrating a coil, a bobbin, and an exterior member together with a part of a mold for molding.

FIG. 5 is an enlarged cross-sectional view of an approximately similar position to FIG. 3 that illustrates a solenoid according to a second embodiment.

FIG. 6 is an enlarged cross-sectional view of an approximately similar position to FIG. 3 that illustrates a solenoid according to a third embodiment.

### DESCRIPTION OF EMBODIMENTS

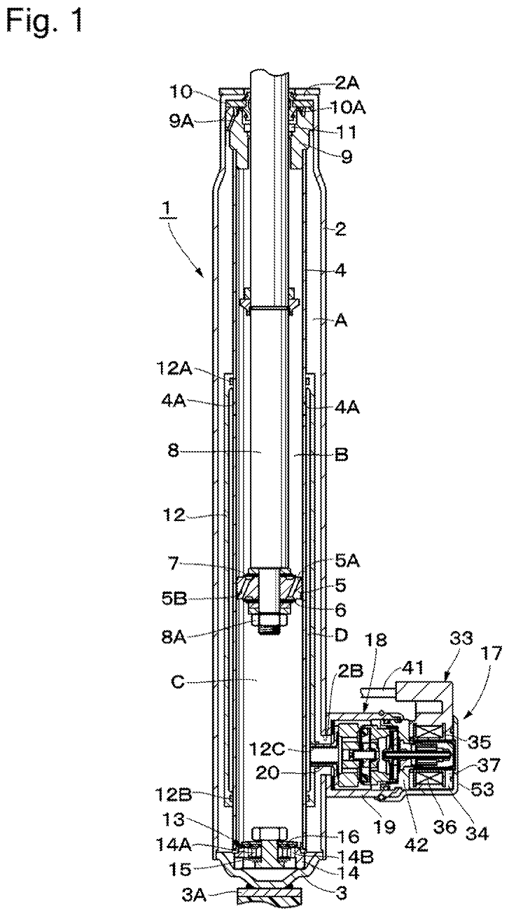

In the following description, solenoids, damping force adjustment mechanisms, and damping force adjustable shock absorbers according to embodiments will be described with reference to the attached drawings citing an example in which they are used for a damping force adjustable hydraulic shock absorber. The attached drawings (FIGS. 1 to 6) are drawings drafted with accuracy equivalent to a design drawing.

FIGS. 1 to 4 illustrate a first embodiment. First, a damping force adjustable hydraulic shock absorber 1 (hereinafter referred to as a hydraulic shock absorber 1) in which a solenoid 33 and a damping force adjustment apparatus 17 as the damping force adjustment mechanism according to the present embodiment are built will be described with reference to FIG. 1.

The hydraulic shock absorber 1 as the damping force adjustable shock absorber includes a bottomed tubular outer tube 2 forming an outer shell. The lower end side of the outer tube 2 is closed by a bottom cap 3 with use of a welding method or the like. A radially inward bent crimped portion 2A is formed on the upper end side of the outer tube 2. A rod guide 9 and a seal member 10 are provided between the crimped portion 2A and an inner tube 4. On the other hand, an opening 2B is formed on the lower portion side of the outer tube 2 concentrically with a connection port 12C of an intermediate tube 12. The damping force adjustment apparatus 17 is attached on the lower portion side of the outer tube 2 so as to face the opening 2B. A mounting eye 3A, which is attached to, for example, the wheel side of a vehicle, is provided to the bottom cap 3.

The inner tube 4 is provided in the outer tube 2 coaxially with the outer tube 2. The lower end side of the inner tube 4 is attached to a bottom valve 13 by being fitted thereto. The upper end side of the inner tube 4 is attached to the rod guide 9 by being fitted thereto. Oil fluid as hydraulic fluid (working fluid) is sealingly contained in the inner tube 4 serving as a cylinder. The hydraulic fluid is not limited to oil fluid and oil, and may be, for example, water containing an additive mixed therein.

An annular reservoir chamber A is formed between the inner tube 4 and the outer tube 2. Gas is sealingly contained in the reservoir chamber A together with the oil fluid. This gas may be air in an atmospheric-pressure state, or gas such as compressed nitrogen gas may be used as it. An oil hole 4A is pierced radially at an intermediate position in the length direction (the axial direction) of the inner tube 4. The oil hole 4A establishes constant communication of a rod-side oil chamber B with an annular oil chamber D.

The piston 5 is slidably fittedly inserted in the inner tube 4. In other words, the piston 5 is provided slidably in the inner tube 4. The piston 5 divides (partitions) the inside of the inner tube 4 into the rod-side oil chamber B and a bottom-side oil chamber C. A plurality of oil passages 5A and a plurality of oil passages 5B are each formed on the piston 5 so as to be circumferentially spaced apart from one another. The oil passages 5A and 5B can establish communication between the rod-side oil chamber B and the bottom-side oil chamber C.

Then, an extension-side disk valve 6 is provided on the lower end surface of the piston 5. The extension-side disk valve 6 is opened upon exceedance of the pressure in the rod-side oil chamber B over a relief setting pressure when the piston 5 is slidably displaced upward during an extension stroke of the piston rod 8, and relieves the pressure at this time by releasing it to the bottom-side oil chamber C side via each of the oil passages 5A. The relief setting pressure is set to a higher pressure than a valve-opening pressure when the damping force adjustment apparatus 17 is set to the hard side.

A compression-side check valve 7 is provided on the upper end surface of the piston 5. The compression-side check valve 7 is opened when the piston 5 is slidably displaced downward during a compression stroke of the piston rod 8, and otherwise is closed. The check valve 7 permits a flow of the oil fluid in the bottom-side oil chamber C through inside each of the oil passages 5B toward the rod-side oil chamber B, and prohibits a flow of the oil fluid in the opposite direction therefrom. The valve-opening pressure of the check valve 7 is set to a lower pressure than a valve-opening pressure when the damping force adjustment apparatus 17 is set to the soft side, and the check valve 7 generates substantially no damping force. Generating substantially no damping force here means a force equal to or weaker than friction of the piston 5 and the seal member 10, and not affecting a motion of the vehicle.

The piston rod 8 extends axially in the inner tube 4. The lower end side of the piston 8 is inserted in the inner tube 4. The piston rod 8 is provided while being fixedly attached to the piston 5 with use of a nut 8A and the like. The upper end side of the piston rod 8 protrudes out of the outer tube 2 and the inner tube 4 via the rod guide 9. In other words, the piston rod 8 is coupled with the piston 5, and extends out of the inner tube 4. The piston rod 8 may be configured as a so-called double rod by further extending the lower end of the piston rod 8 to cause it to protrude outward from the bottom portion (for example, the bottom cap 3) side.

The stepped cylindrical rod guide 9 is provided on the upper end side of the inner tube 4. The rod guide 9 positions the upper portion of the inner tube 4 at the center of the outer tube 2, and also axially slidably guides the piston rod 8 on the inner peripheral side thereof. The annular seal member 10 is provided between the rod guide 9 and the crimped portion 2A of the outer tube 2. The seal member 10 is formed by, for example, baking an elastic member such as rubber to a metallic disk plate including a hole formed at the center thereof for insertion of the piston rod 8. The seal member 10 seals between the piston rod 8 and the outer tube 2 with the aid of sliding contact of the inner periphery of the elastic material thereof with the outer peripheral side of the piston rod 8.

A lip seal 10A is formed on the seal member 10 on the lower surface side thereof. The lip seal 10A serves as a check valve extending so as to contact the rod guide 9. The lip seal 10A is disposed between an oil pool chamber 11 and the reservoir chamber A. The lip seal 10A permits a flow of the oil fluid and the like in the oil pool chamber 11 toward the reservoir chamber A side via a return passage 9A of the rod guide 9, and prohibits a flow in the opposite direction therefrom.

The intermediate tube 12 is arranged between the outer tube 2 and the inner tube 4. The intermediate tube 12 is, for example, attached to the outer peripheral side of the inner tube 4 via upper and lower tubular seals 12A and 12B. The intermediate tube 12 forms therein the annular oil chamber D extending so as to surround the outer peripheral side of the inner tube 4 over the entire circumference thereof. The annular oil chamber D is provided as an oil chamber independent of the reservoir chamber A. The annular oil chamber D is in constant communication with the rod-side oil chamber B via the radial oil hole 4A formed on the inner tube 4. The connection port 12C is provided on the lower end side of the intermediate tube 12. A tubular holder 20 of a damping force adjustment valve 18 is attached to the connection port 12C.

The bottom valve 13 is provided between the bottom cap 3 and the inner tube 4 at a position on the lower end side of the inner tube 4. The bottom valve 13 includes a valve body 14, a compression-side disk valve 15, and an extension-side check valve 16. The valve body 14 defines (partitions) the reservoir chamber A and the bottom-side oil chamber C between the bottom cap 3 and the inner tube 4. The compression-side disk valve 15 is provided on the lower surface side of the valve body 14. The extension-side check valve 16 is provided on the upper surface side of the valve body 14. Oil passages 14A and 143 are each formed on the valve body 14 at circumferential intervals. The oil passages 14A and 14B can establish communication between the reservoir chamber A and the bottom-side oil chamber C.

The compression-side disk valve 15 is opened upon exceedance of the pressure in the bottom-side oil chamber C over a relief setting pressure when the piston 5 is slidably displaced downward during the compression stroke of the piston rod 8, and relieves the pressure at this time by releasing it to the reservoir chamber A side via each of the oil passages 14A. The relief setting pressure is set to a higher pressure than the valve-opening pressure when the damping force adjustment apparatus 17 is set to the hard side.

The extension-side check valve 16 is opened when the piston 5 is slidably displaced upward during the extension stroke of the piston rod 8, and otherwise is closed. This check valve 16 permits a flow of the oil fluid in the reservoir chamber A through inside each of the oil passages 14B toward the bottom-side oil chamber C. and prohibits a flow of the oil fluid in the opposite direction therefrom. The valve-opening pressure of the check valve 16 is set to a lower pressure than the valve-opening pressure when the damping force adjustment apparatus 17 is set to the soft side, and the check valve 16 generates substantially no damping force.

Next, the damping force adjustment apparatus 17 for variably adjusting the damping force to be generated by the hydraulic shock absorber 1 will be described.

As illustrated in FIG. 1, the proximal end side of the damping force adjustment apparatus 17 (the left end side in FIG. 1) is disposed so as to be located between the reservoir chamber A and the annular oil chamber D, and the distal end side of the damping force adjustment apparatus 17 (the right end side in FIG. 1) is provided so as to protrude from the lower portion side of the outer tube 2 radially outward. The damping force adjustment apparatus 17 generates the damping force by controlling a flow of the oil fluid from the annular oil chamber D to the reservoir chamber A with use of the damping force adjustment valve 18. Further, the damping force adjustment apparatus 17 variably adjusts the damping force to generate by adjusting the valve-opening pressure of the damping force adjustment valve 18 by the solenoid 33 used as a damping force variable actuator. The damping force adjustment apparatus 17 generates the damping force by controlling a flow of the hydraulic fluid (the oil fluid) that is generated according to a sliding movement of the piston 5 in the inner tube 4.

Then, the damping force adjustment valve 18 includes a generally cylindrical valve case 19, the tubular holder 20, a valve member 21, and the like. The valve case 19 is provided in such a manner that the proximal end side thereof is fixedly attached around the opening 2B of the outer tube 2 and the distal end side thereof protrudes from the outer tube 2 radially outward. The tubular holder 20 is provided in such a manner that the proximal end side thereof is fixed to the connection port 12C of the intermediate tube 12, and the distal end side thereof forms an annular flange portion 20A and is arranged inside the valve case 19 with a space created therebetween. The valve member 21 is in contact with the flange portion 20A of this tubular holder 20.

The proximal end side of the valve case 19 forms an inner flange portion 19A protruding radially inward, and an entire circumferential groove 19B is formed on the distal end side of the valve case 19. An engagement ring 54 for crimping and coupling a cover member 53 of the solenoid 33 is attached in the entire circumferential groove 198. A space among the inner peripheral surface of the valve case 19, the valve member 21, the outer peripheral surface of a pilot body 26, and the like forms an annular oil chamber 19C leading to the reservoir chamber A.

The inner side of the tubular holder 20 forms an oil passage 20B having one side in communication with the annular oil chamber D and the opposite side extending to the position of the valve member 21. Further, a spacer 22 is sandwiched between the flange portion 20A of the tubular holder 20 and the inner flange portion 19A of the valve case 19. A cutout 22A serving as an oil passage is formed on the spacer 22. The shock absorber 1 is assumed to be configured to include the spacer 22 with the cutout 22A formed thereon in the present embodiment, but may be configured in such a manner that a cutout for forming the oil passage is radially formed on the inner flange portion 19A instead of the spacer 22. One component can be omitted by employing such a configuration.

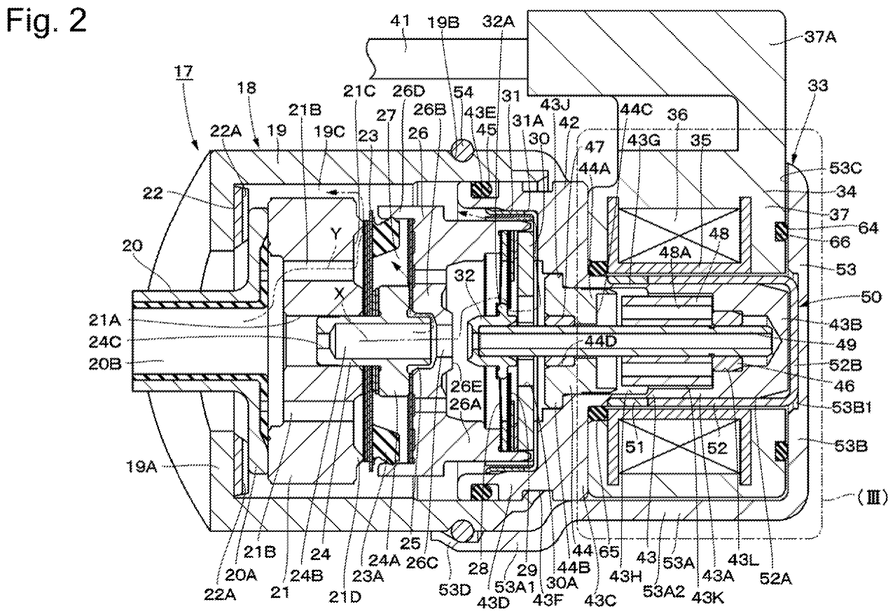

An axially extending central hole 21A is provided on the valve member 21 at the radially central position thereof. Further, a plurality of oil passage 21B is provided on the valve member 21 around the central hole 21A so as to be circumferentially spaced apart from one another. One side of each of the oil passages 21B (the left side in FIGS. 1 and 2) is in constant communication with the oil passage 20B side of the tubular holder 20. Further, an annular recessed portion 21C and an annular valve seat 21D are provided on the end surface of the valve member 21 on the opposite side thereof (the right side in FIGS. 1 and 2). The annular recessed portion 21C is formed so as to surround the openings of the oil passages 21B on the opposite side. The annular valve seat 21D is located on the radially outer side of this annular recessed portion 21C. A main disk valve 23 is seated on and separated from the annular valve seat 21D. Now, the oil passages 21B of the valve member 21 allow the oil fluid to flow between the annular oil chamber D side (the oil passages 20B corresponding thereto) and the reservoir chamber A side (the oil chamber 19C corresponding thereto) via the main disk valve 23.

The main disk valve 23, which forms a main valve, is provided in such a manner that the inner peripheral side thereof is sandwiched between the valve member 21 and a large-diameter portion 24A of a pilot pin 24, and the outer peripheral side thereof is seated on the annular valve seat 21D of the valve member 21. An elastic seat member 23A is fixedly attached to the outer peripheral portion of the main disk valve 23 on the back surface side thereof. The main disk valve 23 is opened by receiving the pressure on the oil passage 21B side of the valve member 21 (the annular oil chamber D side) and being separated from the annular valve seat 21D, and establishes communication of the oil passages 21B of the valve member 21 (the annular oil chamber D side) with the oil chamber 19C (the reservoir chamber A side).

The pilot pin 24 is formed into a stepped cylindrical shape including the large-diameter portion 24A at an axially intermediate portion thereof, and an axially extending central hole 248 at the radially central portion thereof. An orifice 24C is formed at one end portion of the central hole 24B. The pilot pin 24 is press-fitted at one end side thereof (the left end side in FIGS. 1 and 2) in the central hole 21A of the valve member 21, and sandwiches the main disk valve 23 between the large-diameter portion 24A and the valve member 21.

The opposite end side of the pilot pin 24 (the right end side in FIGS. 1 and 2) is fitted in a central hole 26C of the pilot body 26. In this state, axially extending oil passages 25 are formed between the central hole 26C of the pilot body 26 and the opposite end side of the pilot pin 24, and the oil passages 25 establish a connection to a back-pressure chamber 27 formed between the main disk valve 23 and the pilot body 26 via them. In other words, a plurality of axially extending oil passages 25 is circumferentially arranged on the side surface of the pilot pin 24 on the opposite end side, and the circumferential positions other than them are press-fitted in the central hole 26C of the pilot body 26.

The pilot body 26 is formed into a generally bottomed tubular shape including a cylindrical portion 26A and a bottom portion 26B. The cylindrical portion 26A includes a stepped hole formed inside it. The bottom portion 26B closes this cylindrical portion 26A. The central hole 26C is provided at the central portion of the bottom portion 26B. The opposite end side of the pilot pin 24 is fitted in the central hole 26C. A protrusion tubular portion 26D is provided on one end side of the bottom portion 26D of the pilot body 26 (the left end side in FIGS. 1 and 2). The protrusion tubular portion 26D protrudes toward the valve member 21 side over the entire circumference at a position on the radially outer side. The elastic seal member 23A of the main disk valve 23 is fluid-tightly fitted to the inner peripheral surface of the protrusion tubular portion 26D, and forms the back-pressure chamber 27 between the main disk valve 23 and the pilot body 26. The inner pressure in the pilot chamber 27 is applied to the main disk valve 23 in a valve-closing direction. i.e., in a direction causing the main disk valve 23 to be seated onto the annular seat member 21D of the valve member 21.

A valve seat portion 26E is provided at the opposite end side of the bottom portion 26B of the pilot body 26 (the right end side in FIGS. 1 and 2) so as to surround the central hole 26C. A pilot valve member 32 is seated on and separated from the valve seat portion 26E. Further, a return spring 28, a disk valve 29, a holding plate 30, and the like are arranged inside the cylindrical portion 26A of the pilot body 26. The return spring 28 biases the pilot valve member 32 in a direction away from the valve seat portion 26E of the pilot body 26. The disk valve 29 forms a fail-safe valve when the solenoid 33 is in a state that no power is supplied thereto (when the pilot valve member 32 is maximumly separated from the valve seat portion 26E). The holding plate 30 includes an oil passage 30A formed on the central side thereof.

A cap 31 is fixedly fitted at the opening end of the cylindrical portion 26A of the pilot body 26 with the return spring 28, the disk valve 29, the holding plate 30, and the like arranged inside this cylindrical portion 26A. Cutouts 31A are formed on this cap 31 at, for example, four positions in the circumferential direction. The cutouts 31A serve as flow passages that allow the oil fluid delivered to the solenoid 33 side via the oil passage 30A of the holding plate 30 to flow toward the oil chamber 19C (the reservoir chamber A side).

The pilot valve member 32, which forms a pilot valve, is generally cylindrically formed. The distal end portion of the pilot valve member 32, i.e., the distal end portion seated on and separated from the valve seat portion 26E of the pilot body 26 has a gradually narrowing tapering shape. An actuation pin 49 of the solenoid 33 is fixedly fitted inside the pilot valve member 32, and the valve-opening pressure of the pilot valve member 32 is adjusted according to power supply to the solenoid 33. The pilot valve member 32 as a control valve is controlled according to a movement of a movable iron core 48. A flange portion 32A, which serves as a spring bearing, is formed on the proximal end side of the pilot valve member 32 over the entire circumference. The flange portion 32A forms a fail-safe valve by contacting against the disk valve 29 when the solenoid 33 is in the state that no power is supplied thereto, i.e., when the pilot valve member 32 is maximumly separated from the valve seat portion 26E as illustrated in FIG. 2.

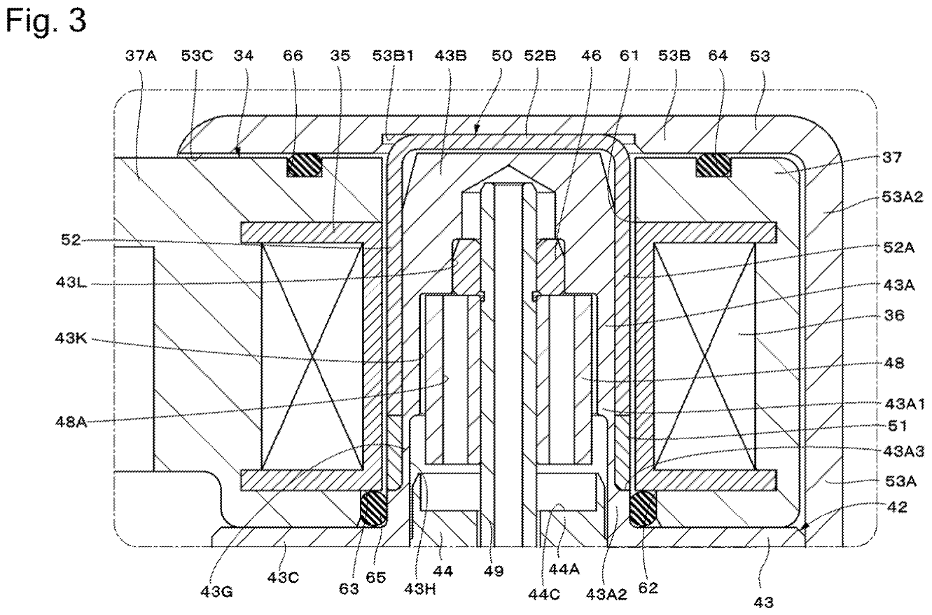

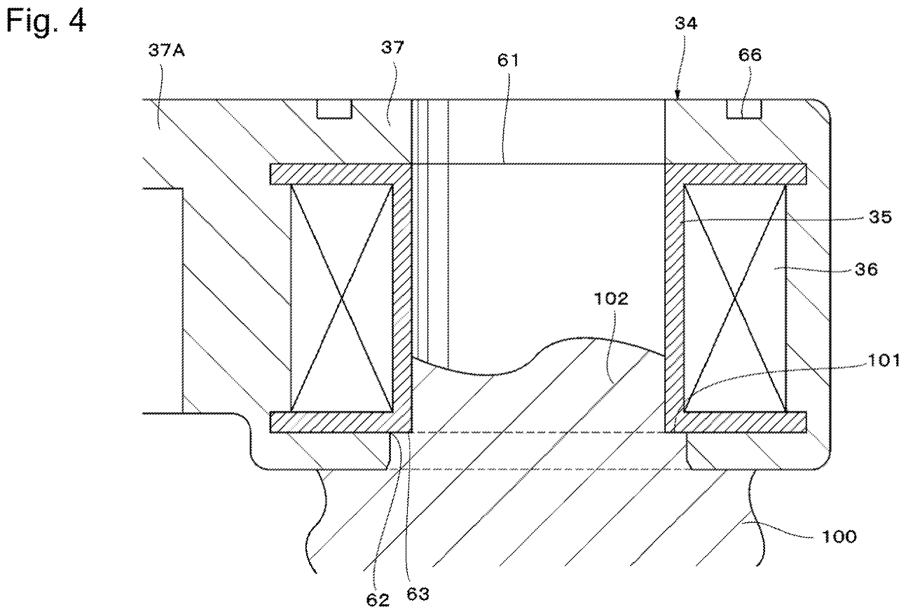

Next, the solenoid 33 forming the damping force adjustment apparatus 17 together with the damping force adjustment valve 18 will be described with additional reference to FIGS. 3 and 4 in addition to FIG. 2. FIG. 3 illustrates a portion III illustrated in FIG. 2 with the right side thereof placed on the upper side. In other words, the vertical direction of FIG. 3 corresponds to the horizontal direction of FIG. 2.

The solenoid 33 is built in the damping force adjustment apparatus 17 as the damping force variable actuator of the damping force adjustment apparatus 17. The solenoid 33 includes a molded coil 34, a stator core 42 including a second member and a stator, the movable iron core 48 as a movable element, the actuation pin 49, a housing member 50, and the cover member 53 including a first member and a third member.

The molded coil 34 includes a bobbin 35, a coil 36, and an exterior member 37. The bobbin 35 is formed as a tubular member including flange portions radially protruding over the entire circumference at the both axial ends thereof, respectively. The coil 36 is wound around the bobbin 35 (between the flange portions of the bobbin 35), and generates a magnetic force in reaction to power supply. The exterior member 37 covers the coil 36 and the bobbin 35 therewith. In other words, the molded coil 34 is generally cylindrically formed by integrally covering (molding) the coil 36 wound around the bobbin 35 with the exterior member 37 such as thermosetting resin.

The cover member 53 (a bottom portion 53B) is disposed on one axial end side of the exterior member 37 (the right end side in FIG. 2 and the upper end side in FIG. 3), and the stator core 42 (a flange portion 43C) is disposed on the opposite axial end side of the exterior member 37 (the left end side in FIG. 2 and the lower end side in FIG. 3). The exterior member 37 serves as a cable extraction portion 37A by a circumferential part thereof protruding radially outward between the cover member 53 (the bottom portion 53B) and the stator core 42 (the flange portion 43C). An electric wire cable 41 is connected to the cable extraction portion 37A. The coil 36 becomes an electromagnet and generates a magnetic force in reaction to power supply through the electric wire cable 41 (power supply).

The stator core 42 is disposed on the inner peripheral side of the coil 36 and is formed into a bottomed tubular shape using a magnetic body (a magnetic material). The stator core 42 includes a stator core main body 43 including the second member and an anchor member 44 as the stator. In the first embodiment, the stator core main body 43 and the anchor member 44 are formed as different components. The stator core main body 43 is formed into a bottomed tubular shape, and includes a cylindrical tubular portion 43A and a bottom portion 43B. The tubular portion 43A has a stepped hole inside it. The bottom portion 43B closes one end side of this tubular portion 43A (the right end side in FIG. 2 and the upper end side in FIG. 3). The tubular portion 43A of the stator core main body 43 is inserted inside the exterior member 37 (i.e., inside the molded coil 34). The flange portion 43C is provided on the tubular portion 43A of the stator core main body 43. The flange portion 43C protrudes radially outward over the entire circumference at a position on the opposite end side of the tubular portion 43A of the stator core main body 43.

The flange portion 43C of the stator core main body 43 corresponds to the second member. More specifically, the flange portion 43C is located on the opposite axial end side where the opposite axial end of the exterior member 37 (the left end in FIG. 2 and the upper end of FIG. 3) is located and the anchor member 44 is disposed (i.e., the opposite axial end side where the pilot valve member 32 is disposed). The outer peripheral side of the flange portion 43C is in contact with a tubular portion 53A (a small-diameter tubular portion 53A2) of the cover member 53. Further, a tubular fitted portion 43D is provided on the radially outer side of the flange portion 43C. The fitted portion 43D protrudes toward the damping force adjustment valve 18 side. The cap 31 of the damping force adjustment valve 18 is fitted on the radially inner side of the fitted portion 43D. The valve case 19 of the damping force adjustment valve 18 is fitted on the radially outer side of the fitted portion 43D.

Then, a seal groove 43A and an engagement groove 43E are each provided over the entire circumference on the outer peripheral surface of the fitted portion 43D in this order starting from the damping force adjustment valve 18 side. A seal ring 45 is attached in the seal groove 43E, and this seal ring 45 oil-tightly seals between the stator core 42 and the valve case 19 of the damping force adjustment valve 18. The opening end edge of the valve case 19 is crimped to the engagement groove 43F.

A thin-walled portion 43G is provided at a portion of the tubular portion 43A of the stator core main body 43 that radially faces the movable iron core 48. The thin-walled portion 43G functions to reduce the cross-sectional area of a magnetic path axially partially. The thin-walled portion 43G is formed by providing an annular recessed portion 43H on the inner peripheral side of the tubular portion 43A of the stator core main body 43. More specifically, as illustrated in FIG. 3, the tubular portion 43A of the stator core main body 43 is configured in such a manner that a fitted tubular portion 43A1 to which the housing member 50 is fitted and a large-diameter tubular portion 43A2 having a larger outer diameter dimension than this fitted tubular portion 43A1 are continuously connected via a stepped surface 43A3.

Then, an annular positioning recessed portion 43J, the annular recessed portion 43H, a facing surface portion 43K, and a bush attachment portion 43L are provided on the inner peripheral side of the tubular portion 43A of the stator core main body 43 in this order starting from the opening side. The positioning recessed portion 43J positions a flange portion 44B of the anchor member 44. A tubular portion 44A of the anchor member 44 is fitted to the recessed portion 43H. The facing surface portion 43K faces the movable iron core 48 via a slight radial space. A bush 46 supporting one end side of the actuation pin 49 is fittedly attached to the bush attachment portion 43L. In this case, the thin-walled portion 43G where the proximal end side of the fitted tubular portion 43A1 is radially thinned in thickness is constructed by forming the recessed portion 43H inside the tubular portion 43A as far as a portion radially overlapping the fitted tubular portion 43A1 with respect to the axial direction of the tubular portion 43A. A magnetic field generated by the coil 36 is saturated due to high magnetic resistance of the thin-walled portion 43G, and is guided to between the movable iron core 48 and the anchor member 44, thereby functioning as a solenoid thrust force.

The bottom portion 43B of the stator core main body 43 tapers from the connection portion with the tubular portion 43A, and the end surface thereof faces a bottom portion 528 of the housing member 50 with a space created therebetween. Due to this configuration, an axial force is prevented from being directly applied from the cover member 53 to the stator core main body 43 via the bottom portion 52B of the housing member 50.

The anchor member 44 is fittedly attached to the opposite end side of the tubular portion 43A of the stator core main body 43 (the left end side in FIGS. 1 and 2). The anchor member 44 attracts the movable iron core 48. The anchor member 44 forms the stator core 42 together with the stator core main body 43. The anchor member 44 is a fixed iron core that attracts the movable iron core 48 when a magnetic force is generated by the coil 36. The anchor member 44 is formed into a stepped cylindrical shape, and includes the tubular portion 44A and the flange portion 44B. The actuation pin 49 is inserted inside the tubular portion 44A. The flange portion 44B protrudes from the outer peripheral surface of the tubular portion 44A radially. A hole portion 44C is provided on the end surface of the tubular portion 44A that faces the movable iron core 48. This movable iron core 48 is inserted in the hole portion 44C when the movable iron core 48 is attracted. Further, a bush attachment portion 44D is provided on the inner side of the anchor member 44. A bush 47, which supports the actuation pin 49, is fittedly attached in the bush attachment portion 441).

The movable iron core 48 as an iron core called a plunger is disposed on the inner side of the stator core 42 and is provided axially movably. In other words, the movable iron core 48 is disposed on the inner peripheral side of the molded coil 34 (more specifically, the coil 36), and is provided axially movably. In this case, the movable iron core 48 is integrally fixed to the actuation pin 49. The actuation pin 49 is supported on the stator core main body 43 and the anchor member 44 via the bushes 46 and 47, respectively. The movable iron core 48 is formed into a generally cylindrical shape with use of, for example, a ferrous magnetic body, and generates a thrust force by being attracted to the anchor member 44 of the stator core 42 when the magnetic force is generated by the coil 36. A communication passage 48A is formed on the movable iron core 48.

The movable iron core 48 is integrally fixed (sub-assembled) to the intermediate portion of the actuation pin 49, which is a member that transmits the thrust force of the movable iron core 48. Both the axial sides of the actuation pin 49 are supported on the stator core 42 via the bushes 46 and 47 axially displaceably. As illustrated in FIG. 2, one end side of the actuation pin 49 (the left end side in FIG. 2) protrudes from the stator core 42, and, along therewith, the pilot valve member 32 of the damping force adjustment valve 18 is fixed to the protrusion end thereof. Therefore, the pilot valve member 32 is integrally moved (displaced) together with the movable iron core 48 and the actuation pin 49. In other words, the valve-opening pressure of the pilot valve member 32 is set to a pressure corresponding to the thrust force of the movable iron core 48 based on power supply to the coil 36.

The housing member 50 is fittedly attached to the tubular portion 43A (the fitted tubular portion 43A 1) of the stator core main body 43. The housing member 50 houses the movable iron core 48 therein. In this case, the housing member 50 houses the movable iron core 48 together with the tubular portion 43A of the stator core 42. The housing member 50 is in contact with the thin-walled portion 43G of the stator core 42 (the stator core main body 43) from the outer peripheral side. Along therewith, one end of the housing member 50 (the left end in FIG. 2 and the lower end in FIG. 3) is in contact with a stepped surface 43A3 of the stator core 42. On the other hand, the opposite end of the housing member 50 (the right end in FIG. 2 and the upper end in FIG. 3) is in contact with the cover member 53. The portion of the housing member 50 that is in contact with the thin-walled portion 43G of the stator core 42 is a nonmagnetic body.

Therefore, the housing member 50 is bottomed as a whole, and is formed by two members, a ring member 51 as a nonmagnetic annular member and a cap member 52 as a ferromagnetic annular member. In other words, the housing member 50 is formed by the tubular ring member 51 provided as a nonmagnetic body serving as the portion in radial contact with the thin-walled portion 43G of the stator core 42, and the bottomed tubular cap member 52 provided as a ferromagnetic body located on the opposite side with respect to this contact portion.

The housing member 50 has a function of protecting (reinforcing) the thin-walled portion 43G of the stator core 42. More specifically, the housing member 50 prevents the thin-walled portion 43G from incurring damage due to a pressure with the aid of the contact of the ring member 51 with the outer peripheral side of the thin-walled portion 43G. In this case, the ring member 51 is made of the nonmagnetic body, thereby achieving the protection of the thin-walled portion 43G while ensuring the saturation of the magnetic flux at the thin-walled portion 43G. The solenoid 33 has been described indicating the configuration in which the cap member 52 is used as the housing member 50 and the stator core main body 43 and the movable iron core 48 are housed in this cap member 52 in the present embodiment, but may be configured to use the stator core main body as the housing member as discussed in, for example, Japanese Patent Application Public Disclosure No. 2013-213588.

On the other hand, the cap member 52 is made of the ferromagnetic body, thereby preventing magnetic resistance from increasing at a portion of the stator core 42 outside the thin-walled portion 43G. The cap member 52 is formed into a bottomed tubular shape including the tubular portion 52A and the bottom portion 52B, and the tubular portion 52A thereof is fitted to the tubular portion 43A (the fitted tubular portion 43A 1) of the stator core main body 43 by, for example, light pressure-fitting. As a result, the tubular portion 52A of the cap member 52 is brought into contact with the stator core main body 43 over a contact area sufficient to create no resistance against the transfer of a magnetic flux. Then, the outer side of the bottom portion 52B of the cap member 52 (the right side in FIGS. 1 and 2 and the upper side in FIG. 3), i.e., the outer surface of the bottom portion 52B that faces the cover member 53 is in contact with this cover member 53. Due to this contact, the cover member 53 can press the ring member 51 together with the cap member 52 so as to prohibit them from being axially displaced, and also facilitate an efficient transfer of a magnetic flux between the cover member 53 and the cap member 52.

On the other hand, a space is created between the inner side of the bottom portion 52B of the cap member 52 (the left side in FIGS. 1 and 2 and the lower side in FIG. 3) and the stator core 42. More specifically, the inner surface of the bottom portion 52B of the cap member 52 that faces the bottom portion 43B of the stator core main body 43 faces the bottom portion 43B of this stator core main body 43 with a slight space (gap) that permits a transfer of a magnetic flux to some degree. Due to this configuration, a force (an axial force) is prevented from being directly applied from the cover member 53 to the stator core 42 via the bottom portion 52B of the cap member 52.

The cover member 53 covers the outer peripheral side of the coil 36 therewith. The cover member 53 is formed as a yoke using a nonmagnetic body (a nonmagnetic material). The cover member 53 forms a magnetic circuit (a magnetic path) on the outer peripheral side of the molded coil 34 (the coil 36). Now, the cover member 53 is formed into a generally bottomed tubular shape. More specifically, the cover member 53 is generally formed by a stepped cylindrical tubular portion 53A including a large-diameter tubular portion 53A1 and a small-diameter tubular portion 53A2, and the bottom portion 53B closing the one end side of this tubular portion 53A. The tubular portion 53A of the cover member 53 corresponds to the third member. In other words, the tubular portion 53A covers the radially outer peripheral side of the molded coil 34, more specifically, the exterior member 37. The bottom portion 53B of the cover member 53 corresponds to the first member. In other words, the bottom portion 53B is disposed on one axial end side of the molded coil 34, more specifically, the exterior member 37 (the right end side in FIG. 2 and the upper end side in FIG. 3). In the present embodiment, the third member and the first member are formed as one integrated member (integrated component) by integrally forming the tubular portion 53A and the bottom portion 53B of the cover member 53.

An axially extending cutout 53C is formed on the tubular portion 53A of the cover member 53. More specifically, the cutout 53C extending from the opening end side to the bottom portion 53B is formed at a portion that is a circumferential part of the tubular portion 53A and corresponds to the cable extraction portion 37A of the molded coil 34. The inner peripheral surface of the tubular portion 53A (the small-diameter tubular portion 53A2) of the cover member 53 faces the outer peripheral surface of the molded coil 34 (the exterior member 37) with a space created therebetween. Due to this configuration, the solenoid 33 is configured in such a manner that a radial force applied to the cover member 53 is not directly applied to the exterior member 37 of the molded coil 34. On the other hand, the solenoid 33 is configured in such a manner that the outer peripheral surface of the flange portion 43C of the stator core main body 43 is in contact with the inner peripheral surface of the tubular portion 53A (the small-diameter tubular portion 53A2) of the cover member 53 by, for example, light press-fitting, thereby allowing a magnetic flux to be transferred between the cover member 53 and the stator core 42.

As illustrated in FIG. 2, a crimped portion 53D, which is radially inward and plastically deformed, is provided at the opening end of the tubular portion 53A (the large-diameter tubular portion 53A1) of the cover member 53. More specifically, the opening end of the tubular portion 53A is crimped to the outer peripheral surface of the valve case 19 with the engagement ring 54 attached in the entire circumferential groove 19B of the valve case 19 of the damping force adjustment valve 18. The solenoid 33 is configured in such a manner that the damping force adjustment valve 18 and the solenoid 33 are integrally coupled with each other by that.

An contact recessed portion 53B1 is provided on the bottom portion 53B of the cover member 53 at a position corresponding to the bottom portion 521B of the cap member 52. The contact recessed portion 531 has an inner diameter dimension larger than the outer diameter dimensions of the tubular portion 52A and the bottom portion 52B of the housing member 50 (the cap member 52). The bottom portion 53B of the cover member 53 is configured to be able to transfer a magnetic flux between the cover member 53 and the cap member 52 by axially contacting against the bottom portion 52B of the cap member 52 at the position of the contact recessed portion 531. In this case, the solenoid 33 is configured in such a manner that a space is created between the bottom portion 52B of the cap member 52 and the bottom portion 43B of the stator core main body 43, by which an axial space is created between the bottom portion 438 of the stator core 42 and the cover member 53. Due to this configuration, a force (an axial force) can be prevented from being directly applied from the cover member 53 to the stator core 42, and an excessive fore can be prevented from being applied to the thin-walled portion 43G of the stator core 42.

The magnetic flux generated by the coil 36 travels through the flange portion 43C of the stator core main body 43, the contact portion between this flange portion 43C and the tubular portion 53A (the small-diameter tubular portion 53A2) of the cover member 53, the cover member 53, the contact portion between the bottom portion 538 of the cover member 53 and the bottom portion 52B of the cap member 52, the cap member 52, the contact portion between the tubular portion 52A of the cap member 52 and the tubular portion 43A (the fitted tubular portion 43A1) of the stator core 42, from the tubular portion 43A to the movable iron core 48, from the movable iron core 48 to the anchor member 44, and the fitted portion (the contact portion) between the anchor member 44 and the stator core main body 43 in this order. In this case, all the transfers of the magnetic flux can be conducted at the contact portions (the portions in planar contact with each other) except for the transfer of the magnetic flux between the movable iron core 48 and the stator core 42 where sliding resistance is undesired, and therefore high magnetic efficiency can be secured.

Now, as described above, the molded coil 34 is formed by integrally covering (molding) the coil 36 wound around the bobbin 35 with the exterior member 37 made from resin. In this case, as illustrated in FIG. 3, two seams, a first seam 61 and a second seam 62 are present between the bobbin 35 and the exterior member 37 on the radially inner side of the molded coil 34. The first seam 61 is a seam where the inner peripheral surface of the exterior member 37 and the inner peripheral surface of the bobbin 35 are connected. More specifically, the first seam 61 is a seam where the inner peripheral surface of the exterior member 37 and the inner peripheral surface of the bobbin 35 are continuously connected due to the fact that the exterior member 37 and the bobbin 35 have equal inner diameters. On the other hand, at the second seam 62, a step 63 is formed between the bobbin 35 and the exterior member 37. More specifically, at the second seam 62, the inner peripheral surface of the exterior member 37 and the inner peripheral surface of the bobbin 35 are connected with the step 63 created therebetween due to the fact that a portion of the exterior member 37 on one end side (the left side in FIG. 2 and the lower side in FIG. 3) with respect to the bobbin 35 has a larger inner diameter than the bobbin 35.

As illustrated in FIG. 4, the step 63 is formed due to contact between an annular base 101 of a mold 100 for the molding and the bobbin 35 when the coil 36 and the bobbin 35 are covered with the exterior member 37 by the molding. In this case, the axial position of the bobbin 35 is regulated due to the contact with the annular base 101 of the mold 100 and the radial position of the bobbin 35 is regulated by fitted engagement with a central tubular portion 102 of the mold 100. As a result, the coil 36 and the bobbin 35 can be highly accurately positioned in the mold 100 when the molding is performed.

Now, the entry of moisture (water) such as rainwater and mud water from outside into the first seam 61 and the second seam 62 is undesirable. More specifically, if no seal means is provided on the upstream side of the first seam 61 and the second seam 62 in a route usable for the moisture to enter (the upstream side in a direction in which the moisture enters from outside), the water may enter the coil 36, resulting in a failure to secure sufficient insulation performance. However, it is undesirable that the provision of a seal means leads to an increase in the axial dimension of the solenoid. That is, the solenoid is desired to have a shorter axial length for the purpose of improving the mountability to the vehicle body.

Under these circumstances, in the first embodiment, a first seal member 64 is provided between the cover member 53 and the exterior member 37, and a second seal member 65 is also provided between the stator core main body 43 and the exterior member 37. In this case, the first seal member 64 is disposed on the upstream side of the first seam 61 (i.e., the upstream side in the direction in which the water enters the solenoid 33 from outside) and between the bottom portion 538 of the cover member 53 and the exterior member 37. To realize that, a seal groove 66 is formed over the entire circumference on the side surface (the axial end surface) of the exterior member 37 of the molded coil 34 that faces the cover member 53. The first seal member 64 is attached in the seal groove 66. The first seal member 64 is formed by a seal ring such as an O-ring annularly formed using an elastic material such as rubber. The first seal member 64 fluid-tightly seals (sealingly separates) between the exterior member 37 of the molded coil 34 and the bottom portion 53B of the cover member 53. Due to this provision, the moisture such as rainwater and mud water is prevented from entering to the coil 36 and bobbin 35 side via between the cover member 53 and the molded coil 34.

Now, the first seal member 64 is a face seal that seals between the outer surface of the exterior member 37 (the bottom surface of the seal groove 66) and the inner surface of the cover member 53 (the bottom surface of the bottom portion 53B) (between flat surfaces). The first seal member 64 seals between the exterior member 37 and the cover member 53 while pressing the exterior member 37 toward the flange portion 43C of the stator core main body 43 based on a tightening margin between the “axial thickness of the first seal member 64 itself” and the “space between the bottom surface of the seal groove 66 of the exterior member 37 and the bottom surface of the bottom portion 53B of the cover member 53”. In other words, the exterior member 37 is disposed while being pressed toward the flange portion 43C of the stator core main body 43 by the first seal member 64. Further, the first seal member 64 is attached in the seal groove 66 of the exterior member 37, and the exterior member 37 is provided between the first seal member 64 and the bobbin 35 by that.

On the other hand, the second seal member 65 is disposed on the upstream side of the second seam 62 (i.e., the upstream side in the direction in which the water enters the solenoid 33 from outside) and between the flange portion 43C of the cover member 43 and the exterior member 37. To realize that, the exterior member 37 has a larger inner diameter between the flange portion 43C and the bobbin 35 than the inner diameter of the bobbin 35. As a result, the step 63 is formed between the side surface of the bobbin 35 and the inner peripheral surface of the exterior member 37. Then, the second seal member 65 is attached between this step 63 and the tubular portion 43A (the large-diameter tubular portion 43A2) of the stator core main body 43. The second seal member 65 is formed by a seal ring such as an O-ring annularly formed using an elastic material such as rubber. The second seal member 65 fluid-tightly seals (sealingly separates) between the exterior member 37 of the molded coil 34 and the tubular portion 43A (the large-diameter tubular portion 43A2) of the cover member 43. Due to this provision, the moisture such as rainwater and mud water is prevented from entering to the coil 36 and bobbin 35 side via between the molded coil 34 and the stator core main body 43.

Now, the second seal member 65 is a shaft seal that seals between the inner peripheral surface of the exterior member 37 and the outer peripheral surface of the tubular portion 43A (the large-diameter tubular portion 43A2) of the stator core main body 43 (between circumferential surfaces). In this case, the second seal member 65 is disposed among the “housing member 50 or the tubular portion 43A (the large-diameter tubular portion 43A2) of the stator core main body 43”, the “bobbin 35 surrounding the housing member 50”, the “exterior member 37”, and the “flange portion 43C of the stator core main body 43”. The second seal member 65 seals between the inner peripheral surface of the exterior member 37 and the outer peripheral surface of the tubular portion 43A (the large-diameter tubular portion 43A2) of the stator core main body 43 based on a tightening margin between the “radial thickness of the second seal member 65 itself” and the “space between the inner peripheral surface of the exterior member 37 and the outer peripheral surface of the tubular portion 43A (the large-diameter tubular portion 43A2) of the stator core main body 43”.

In this manner, the solenoid 33 according to the first embodiment includes the bobbin 35, the exterior member 37, the first seal member 64, and the second seal member 65. The second seal member 65 is contained at the step 63 provided between the bobbin 35 and the exterior member 37. The second seal member 65 is a shaft seal disposed between the outer periphery of the tubular portion 43A (the large-diameter tubular portion 43A2) of the stator core main body 43 serving as a magnetic circuit member and the inner periphery of the portion of the exterior member 37 that is located between the flange portion 43C of the stator core main body 43 and the bobbin 35, and sealing these circumferential surfaces. The second seam 62, which corresponds to an interface between the bobbin 35 and the exterior member 37, is located on the deeper side than the portion sealed by the second seal member 65, i.e., the downstream side in the direction in which the moisture enters. Due to this layout, the second seam 62 is disposed at a position where it is prevented from being immersed in the water with the aid of the second seal member 65.

On the other hand, the first seal member 64 is contained in the seal groove 66 provided on the exterior member 37. The first seal member 64 is a face seal disposed between the bottom surface of the seal groove 66 and the bottom surface of the bottom portion 53B of the cover member 53 and sealing these bottom surfaces (the flat surfaces). The first seam 61, which corresponds to an interface between the bobbin 35 and the exterior member 37, is located on the deeper side than the portion sealed by the first seal member 64, i.e., the downstream side in the direction in which the moisture enters. Due to this layout, the first seam 61 is disposed at a position where it is prevented from being immersed in the water with the aid of the first seal member 64. In other words, in the first embodiment, the two seams (interfaces), the first seam 61 and the second seam 62 are provided on the inner side with respect to the first seal member 64 and the second seal member 65, and therefore the two seams 61 and 62 can be prevented from being immersed in the water.

Further, the second seal member 65 is a shaft seal and the first seal member 64 is a face seal, and therefore the exterior member 37 is pressed against the opposite axial end side where the flange portion 43C of the stator core main body 43 serving as the magnetic circuit member is located. Therefore, the tightening margin of the first seal member 64 is uniquely determined. In addition, vibration insulation is established between the exterior member 37 and the cover member 53 with the aid of the first seal member 64, and therefore the generation of PWM noise due to the actuation of the solenoid 33 can be suppressed. Further, the step 63, at which the second seal member 65 is contained, is formed by exposing the side surface (the bottom surface) of the bobbin 35. Therefore, the step 63 can axially position the bobbin 35 and the coil 36 in the mold 100 for performing the molding when the coil 36 and the bobbin 35 are covered with the exterior member 37 by the molding.

The solenoid 33 according to the present embodiment and the hydraulic shock absorber 1 in which this solenoid 33 is built are configured in the above-described manner, and the functions thereof will be described next.

First, when the hydraulic shock absorber 1 is mounted on the vehicle such as the automobile, for example, the upper end side of the piston rod 8 is attached to the vehicle body side of the vehicle, and the mounting eye 3A side provided on the bottom cap 3 is attached to the wheel side. Further, the electric wire cable 41 of the solenoid 33 is connected to, for example, a controller of the vehicle.

When the vehicle runs, upon occurrence of a vertical vibration due to unevenness of a road surface or the like, the piston rod 8 is displaced so as to extend or compress from and into the outer tube 2, and therefore the damping force can be generated by the damping force adjustment apparatus 17 or the like and the vibration of the vehicle can be damped. At this time, the damping force to be generated by the hydraulic shock absorber 1 can be variably adjusted by controlling the value of a current to be supplied to the coil 36 of the solenoid 33 with use of the controller to thus adjust the valve-opening pressure of the pilot valve member 32.

For example, during the extension stroke of the piston rod 8, the compression-side check valve 7 of the piston 5 is closed due to the movement of the piston 5 in the inner tube 4. Before the disk valve 6 of the piston 5 is opened, the oil fluid in the rod-side oil chamber B is pressurized, thereby flowing into the oil passage 20B of the tubular holder 20 of the damping force adjustment valve 18 via the oil hole 4A of the inner tube 4, the annular oil chamber D. and the connection port 12C of the intermediate tube 12. At this time, the oil fluid flows from the reservoir chamber A into the bottom-side oil chamber C by opening the extension-side check valve 16 of the bottom valve 13 by an amount corresponding to the movement of the piston 5. When the pressure in the rod-side oil chamber B reaches the valve-opening pressure of the disk valve 6, this disk valve 6 is opened and relieves the pressure in the rod-side oil chamber B by releasing it into the bottom-side oil chamber C.

In the damping force adjustment apparatus 17, before the main disk valve 23 is opened (in a low piston speed region), the oil fluid transmitted into the oil passage 20B of the tubular holder 20 is delivered into the pilot body 26 by passing through the central hole 21A of the valve member 21, the central hole 24B of the pilot pin 24, and the central hole 26C of the pilot body 26, and pushing and opening the pilot valve member 32, as indicated by an arrow X in FIG. 2. Then, the oil fluid delivered into the pilot body 26 is introduced into the reservoir chamber A by passing through between the flange portion 32A of the pilot valve member 32 and the disk valve 29, the oil passage 30A of the holding plate 30, the cutouts 31A of the cap 31, and the oil chamber 19C of the valve case 19. When the pressure in the oil passage 20B of the tubular holder 20, i.e., the pressure in the rod-side oil chamber B reaches the valve-opening pressure of the main disk valve 23 according to an increase in the piston speed, the oil fluid delivered into the oil passage 20B of the tubular holder 20 is introduced into the reservoir chamber A by passing through the oil passages 21B of the valve member 21, pushing and opening the main disk valve 23, and passing through the oil chamber 19C of the valve case 19, as indicated by an arrow Y in FIG. 2.

On the other hand, during the compression stroke of the piston rod 8, the compression-side check valve 7 of the piston 5 is opened and the extension-side check valve 16 of the bottom valve 13 is closed due to the movement of the piston 5 in the inner tube 4. Before the bottom valve 13 (the disk valve 15) is opened, the oil fluid in the bottom-side oil chamber C flows into the rod-side oil chamber B. Along therewith, the oil fluid flows from the rod-side oil chamber B into the reservoir chamber A via the damping force adjustment valve 18 by passing through a similar route to the route during the extension stroke by an amount corresponding to the entry of the piston rod 8 into the inner tube 4. When the pressure in the bottom-side oil chamber C reaches the valve-opening pressure of the bottom valve 13 (the disk valve 15), the bottom valve 13 (the disk valve 15) is opened and relieves the pressure in the bottom-side oil chamber C by releasing it into the reservoir chamber A.

As a result, during the extension stroke and the compression stroke of the piston rod 8, the damping force is generated due to the orifice 24C of the pilot pin 24 and the valve-opening pressure of the pilot valve member 32 before the main disk valve 23 of the damping force adjustment valve 18 is opened, and is generated according to the valve lift of the main disk valve 23 after this main disk valve 23 is opened. In this case, the damping force can be directly controlled regardless of the piston speed by adjusting the valve-opening pressure of the pilot valve member 32 using the power supply to the coil 36 of the solenoid 33.

More specifically, reducing the current applied to the coil 36 to reduce the thrust force on the movable iron core 48 leads to a reduction in the valve-opening pressure of the pilot valve member 32, thereby resulting in generation of a soft-side damping force. On the other hand, increasing the current applied to the coil 36 to increase the thrust force on the movable iron core 48 leads to an increase in the valve-opening pressure of the pilot valve member 32, thereby resulting in generation of a hard-side damping force. At this time, the valve-opening pressure of the pilot valve member 32 causes a change in the inner pressure in the back-pressure chamber 27 in communication via the oil passages 25 on the upstream side thereof. According thereto, controlling the valve-opening pressure of the pilot valve member 32 can be accompanied by adjusting the valve-opening pressure of the main disk valve 23 at the same time, thereby resulting in an increase in the adjustable range of the damping force characteristic.

In a case where the thrust force on the movable iron core 48 is lost due to, for example, a wire breakage of the coil 36, the pilot valve member 32 is retracted (displaced in the direction away from the valve seat portion 26E) by the return spring 28, and the flange portion 32A of the pilot valve member 32 and the disk valve 29 contact against each other. In this state, a damping force can be generated due to the valve-opening pressure of the disk valve 29, and a required damping force can be acquired even at the time of a malfunction such as a wire breakage of the coil.

Further, when the vehicle runs, moisture such as rainwater and mud water may enter via between the cover member 53 and the molded coil 34 and/or between the molded coil 34 and the stator core main body 43. According to the first embodiment, the first seal member 64 is disposed on the upstream side of the first seam 61 (i.e., the upstream side in the direction in which the water enters from outside) between the cover member 53 and the exterior member 37. On the other hand, the second seal member 65 is disposed on the upstream side of the second seam 61 (i.e., the upstream side in the direction in which the water enters from outside) between the stator core main body 43 and the exterior member 37.

Therefore, the first seam 61 between the bobbin 35 and the exterior member 37 can be sealed by the first seal member 64, and the second seam 62 between the bobbin 35 and the exterior member 37 can be sealed by the second seal member 65. As a result, the solenoid 33 can improve the sealing performance for the first seam 61 and the second seam 62 between the bobbin 35 and the exterior member 37. More specifically, since the first seam 61 and the second seam 62, which correspond to the interfaces between the bobbin 35 and the exterior member 37, are provided on the inner side with respect to the first seal member 64 and the second seal member 65, these interfaces can be reliably waterproofed regardless of the joining condition of the interface between the bobbin 35 and the exterior member 37.

According to the first embodiment, the first seal member 64 is a face seal and the second seal member 65 is a shaft seal. Therefore, the first seal member 64 can seal between the outer surface of the exterior member 37 (the bottom surface of the seal groove 66) and the inner surface of the cover member 53 (the bottom surface of the bottom portion 53B). Further, the second seal member 65 can seal between the inner peripheral surface of the exterior member 37 (the inner peripheral surface of the exterior member 37 between the bobbin 35 and the flange portion 43C of the stator core main body 43) and the outer peripheral surface of the stator core main body 43 (the outer peripheral surface of the large-diameter tubular portion 43A2 of the tubular portion 43A). More specifically, the first seal member 64 can seal between the outer surface of the exterior member 37 and the inner surface of the cover member 53 while pressing the exterior member 37 toward the flange portion 43C of the stator core main body 43 based on the tightening margin between the “axial thickness of the first seal member 64 itself” and the “space of the portion in which the first seal member 64 is disposed between the outer surface of the exterior member 37 and the inner surface of the cover member 53”.

Further, the second seal member 65 seals between the inner peripheral surface of the exterior member 37 and the outer peripheral surface of the stator core main body 43 based on the tightening margin between the “radial thickness of the second seal member 65 itself” and the “space of the portion in which the second seal member 65 is disposed between the inner peripheral surface of the exterior member 37 and the outer peripheral surface of the stator core main body 43”. In this case, the first seal member 64 and the second seal member 65 can have different specifications (the direction of the surface to seal and how the surface is scaled), and therefore can, for example, secure the sealing performance while absorbing a linear expansion difference when the temperature increases. Further, the present configuration can facilitate assembling the cover member 53, the first seal member 64, the molded coil 34, the second seal member 65, and the stator core main body 43, thereby also improving the productivity. More specifically, since employing a shaft seal as one of the first seal member 64 and the second seal member 65 and also employing a face seal as the other of them, the solenoid 33 can allow the exterior member 37 containing the coil 36 therein to be pressed against one of the axial sides and can also allow the tightening margin of the face seal to be clearly determined. In addition, the solenoid 33 can also prevent an increase in the axial length thereof due to the first seal member 64 and the second seal member 65, thereby also achieving a reduction in the size thereof (a reduction in the axial length) and thus improving the mountability of the hydraulic shock absorber 1 with the solenoid 33 built therein to the vehicle body.

Now, supposing that face seals are employed as both the first seal member and the second seal member, a possible consequence in this case will be described now. In this case, spaces may be created at the top and the bottom due to the fact that the molded coil including the coil, the bobbin, and the exterior member floats from the cover member due to the first seal member and the second seal member. That is, this case makes it impossible to clearly determine the squeeze of the seal member, and, in addition, facilitates transmission of a vibration due to PWM power supply, thereby raising a possibility of causing noise generation. On the other hand, in the present embodiment, the solenoid 33 employs a face seal as the first seal member 64 and also employs a shaft seal as the second seal member 65 (employ different types of seals), thereby being able to apply the elastic forces of the seal members in different directions. As a result, the solenoid 33 can allow the tightening margin to be uniquely determined and also impede the transmission of a vibration due to PWM power supply.

According to the first embodiment, the second seal member 65 is disposed among the housing member 50, the bobbin 35, the exterior member 37, and the stator core main body 43. Therefore, the solenoid 33 can seal among the housing member 50, the bobbin 35, the exterior member 37, and the stator core main body 43 using the second seal member 65, which is a shaft seal.

According to the first embodiment, the exterior member 37 is disposed while being pressed toward the stator core main body 43 by the first seal member 64. More specifically, with the aid of the first seal member 64, which is a face seal, the solenoid 33 can seal between the outer surface of the exterior member 37 and the inner surface of the cover member 53 while pressing the exterior member 37 toward the stator core main body 43 corresponding to the direction away from the cover member 53 based on the tightening margin between the “axial thickness of the first seal member 64 itself” and the “space of the portion in which the first seal member 64 is disposed between the outer surface of the exterior member 37 and the inner surface of the cover member 53”. In this case, the solenoid 33 can suppress direct transmission of a vibration (PWM noise) from the outer surface of the exterior member 37 to the inner surface of the cover member 53 with the aid of the first seal member 64, thereby suppressing an outward leak of this vibration (noise). More specifically, the solenoid 33 can establish the vibration isolation between the exterior member 37 containing the coil 36 therein and the cover member 53 to thus suppress PWM noise by employing the face seal as the first seal member 64, which is located on the top panel surface side. In other words, since the exterior member 37 (the molded coil 34) is not pressed outward (to the cover member 53 side) but is pressed inward (to the opposite axial end side where the flange portion 43C of the stator core main body 43 is located), the solenoid 33 can impede an outward leak of PWM noise.

According to the first embodiment, the second seam 62 is formed at the step 63 between the bobbin 35 and the exterior member 37. Therefore, the step 63 of the second seam 62 can be positioned at the contact position between the mold 100, which is the mold used when the coil 36 and the bobbin 35 are covered with the exterior member 37 by the molding, and the bobbin 35. In sum, the bobbin 35 can be positioned in the mold 100 when being subjected to the molding based on the step 63.

According to the first embodiment, the exterior member 37 is provided between the first seal member 64 and the bobbin 35. Therefore, the exterior member 37 can be poured as far as the first seam 61 having no step between the exterior member 37 and the bobbin 35 when the coil 36 and the bobbin 35 are covered with the exterior member 37 by the molding.

According to the first embodiment, both of the stator core 42 (the second member) and the cover member 53 (the first and third members) are made from magnetic materials. Therefore, the magnetic circuit (the magnetic path) can be constructed using the stator core 42 and the cover member 53.

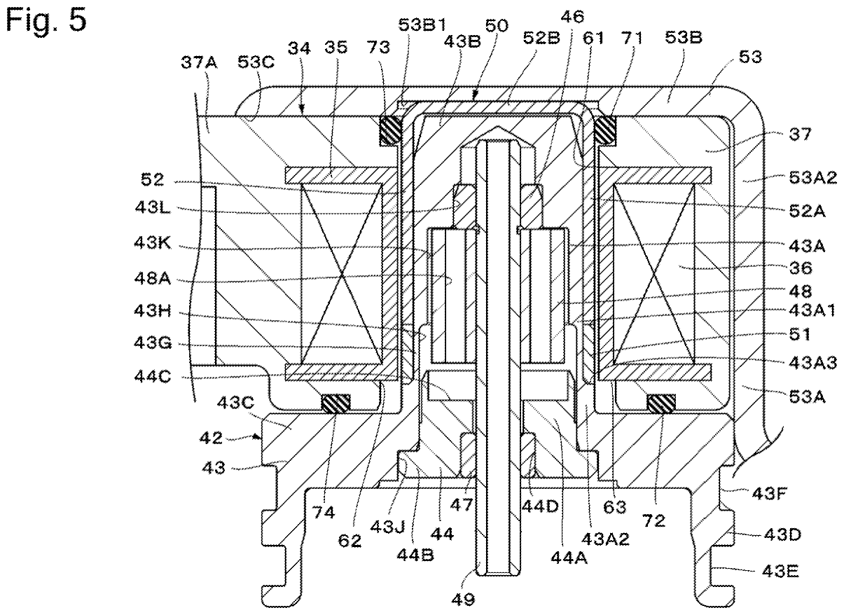

Next, FIG. 5 illustrates a second embodiment. The second embodiment is characterized in that a shaft seal is employed as the first seal member and a face seal is employed as the second seal member. The second embodiment will be described, identifying similar components to the above-described first embodiment by the same reference numerals and omitting descriptions thereof.

In the second embodiment, a first seal member 71 is provided among the cover member 53, the exterior member 37, and the housing member 50, and a second seal member 72 is provided between the stator core main body 43 and the exterior member 37. The first seal member 71 is disposed on the upstream side of the first seam 61 and between the cover member 53 and the exterior member 37. To realize that, a step 73, which has an inner diameter dimension larger than other portions, is formed over the entire circumference on the inner peripheral edge of the one axial end side of the exterior member 37 that faces the cover member 53. More specifically, the step 73, which is formed as an annular recessed portion by a portion having an equal inner diameter dimension to the bobbin 35 and a portion having an inner diameter dimension larger than this portion, is provided at the portion of the exterior member 37 that is located between the cover member 53 and the bobbin 35.

Then, the first seal member 71 is attached in the step 73, more specifically, among the inner peripheral surface and the side surface of the step 73, the outer peripheral surface of the housing member 50 (the tubular portion 52A of the cap member 52), and the inner surface (the bottom surface) of the cover member 53 (the bottom portion 53B). The first seal member 71 fluid-tightly seals (sealingly separates) between the exterior member 37 of the molded coil 34 and the cap member 52 of the housing member 50. Due to this provision, moisture such as rainwater and mud water is prevented from entering to the coil 36 and bobbin 35 side via between the cover member 53 and the molded coil 34.

Now, the first seal member 71 is a shaft seal that seals between the inner peripheral surface of the exterior member 37 and the outer peripheral surface of the cap member 52 (the tubular portion 52A) of the housing member 50 (between circumferential surfaces). In this case, the first seal member 71 is disposed among the “housing member 50”, the “exterior member 37”, and the “bottom portion 53B of the cover member 53”. The first seal member 71 seals between the exterior member 37 and the cover member 50 based on a tightening margin between the “radial thickness of the first seal member 71 itself” and the “space between the inner peripheral surface of the step 73 of the exterior member 37 and the outer peripheral surface of the cap member 52 (the tubular portion 52A) of the housing member 50”. Due to this provision, the moisture such as rainwater and mud water is prevented from entering to the coil 36 and bobbin 35 side via between the exterior member 37 and the cap member 52. Further, the first seal member 71 is attached in the step 73 of the exterior member 37, and the exterior member 37 is provided between the first seal member 71 and the bobbin 35 by that.

On the other hand, the second seal member 72 is disposed on the upstream side of the second seam 62 and between the flange portion 43C of the stator core main body 43 and the exterior member 37. To realize that, a seal groove 74 is formed over the entire circumference on the side surface (the axial end surface) of the exterior member 37 of the molded coil 34 that faces the flange portion 43C of the stator core main body 43. The second seal member 72 is attached in the seal groove 74. The second seal member 72 fluid-tightly seals (sealingly separates) between the exterior member 37 of the molded coil 34 and the flange portion 43C of the stator core main body 43. Due to this provision, the moisture such as rainwater and mud water is prevented from entering to the coil 36 and bobbin 35 side via between the stator core 42 and the molded coil 34.

Now, the second seal member 72 is a face seal that seals between the outer surface of the exterior member 37 (the bottom surface of the seal groove 74) and the inner surface of the stator core 42 (the stator core main body 43) (the side surface of the flange portion 43C) (between flat surfaces). The second seal member 72 seals between the exterior member 37 and the stator core main body 43 while pressing the exterior member 37 toward the bottom portion 53B of the cover member 53 based on a tightening margin between the “axial thickness of the second seal 72 itself” and the “space between the bottom surface of the seal groove 74 of the exterior member 37 and the side surface of the flange portion 43C of the stator core main body 43”. In other words, the exterior member 37 is disposed while being pressed toward the bottom portion 53B of the cover member 53 by the second seal member 72. Further, the second seal member 72 is attached in the seal groove 74 of the exterior member 37, and the exterior member 37 is provided between the second seal member 72 and the bobbin 35 by that.

In this manner, the solenoid 33 according to the second embodiment includes the bobbin 35, the exterior member 37, the first seal member 71, and the second seal member 72. On the other hand, the second seal member 72 is contained in the seal groove 74 provided on the exterior member 37. The second seal member 72 is a face seal disposed between the bottom surface of the seal groove 74 and the side surface of the flange portion 43C of the stator core main body 43 and sealing these surfaces (the flat surfaces). The second seam 62, which corresponds to an interface between the bobbin 35 and the exterior member 37, is located on the deeper side than the portion sealed by the second seal member 72, i.e., the downstream side in the direction in which the moisture enters. Due to this layout, the second seam 62 is disposed at a position where it is prevented from being immersed in the water with the aid of the second seal member 72.

On the other hand, the first seal member 71 is contained in the step 73 provided on the radially inner side of the exterior member 37. The first seal member 71 is a shaft seal disposed between the outer periphery of the housing member 50 (the tubular portion 52A of the cap member 52) serving as the magnetic circuit member and the inner periphery of the step 73 of the exterior member 37, and sealing these circumferential surfaces. The first seam 61, which corresponds to an interface between the bobbin 35 and the exterior member 37, is located on the deeper side than the portion sealed by the first seal member 71, i.e., the downstream side in the direction in which the moisture enters. Due to this layout, the first scam 61 is disposed at a position where it is prevented from being immersed in the water with the aid of the first seal member 71. In other words, in the second embodiment, the two seams (interfaces), the first seam 61 and the second seam 62 are also provided on the inner side with respect to the first seal member 71 and the second seal member 72, and therefore the two seams 61 and 62 can also be prevented from being immersed in the water, similarly to the first embodiment. Further, the first seal member 71 is a shaft seal and the second seal member 72 is a face seal, and therefore the exterior member 37 is pressed against the one axial end side where the bottom portion 53B of the cover member 53 serving as the magnetic circuit member is located. Therefore, the tightening margin of the second seal member 72 is uniquely determined.

The second embodiment is configured to achieve sealing using the first seal member 71 and the second seal member 72 as described above, and basic functions thereof are not especially different from the above-described functions according to the first embodiment. Especially, in the second embodiment, the first seal member 71 is a shaft seal and the second seal member 72 is a face seal. Therefore, the first seal member 71 can seal between the inner peripheral surface of the exterior member 37 (the inner peripheral surface of the step 73) and the outer peripheral surface of the housing member 50 (the outer peripheral surface of the tubular portion 52A of the cap member 52). Further, the second seal member 72 can seal between the outer surface of the exterior member 37 (the bottom surface of the seal groove 74) and the inner surface of the stator core main body 43 (the side surface of the flange portion 43C).

That is, the first seal member 71 can seal between the inner peripheral surface of the exterior member 37 and the outer peripheral surface of the housing member 50 based on the tightening margin between the “radial thickness of the first seal member 71 itself” and the “space of the portion in which the first seal member 71 is disposed between the inner peripheral surface of the exterior member 37 and the outer peripheral surface of the housing member 50”. Further, the second seal member 72 can seal between the outer surface of the exterior member 37 and the inner surface of the stator core main body 43 while pressing the exterior member 37 toward the cover member 53 based on the tightening margin between the “axial thickness of the second seal member 72 itself” and the “space of the portion in which the second seal member 72 is disposed between the outer surface of the exterior member 37 and the inner surface of the stator core main body 43”. In this case, the first seal member 71 and the second seal member 72 can have different specifications (the direction of the surface to seal), and therefore can, for example, secure the sealing performance while absorbing a linear expansion difference when the temperature increases. More specifically, since employing a shaft seal as one of the first seal member 71 and the second seal member 72 and also employing a face seal as the other of them, the solenoid 33 can allow the exterior member 37 containing the coil 36 therein to be pressed against one of the axial sides and can also allow the tightening margin of the face seal to be clearly determined.

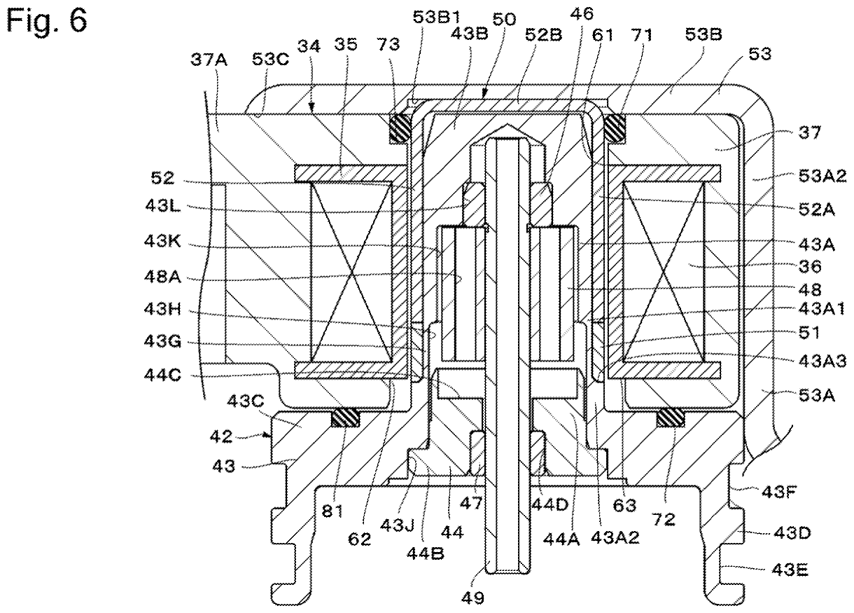

Next, FIG. 6 illustrates a third embodiment. The third embodiment is characterized in that the seal groove used to attach the second seal member is provided on the stator core. The third embodiment will be described, identifying similar components to the above-described first and second embodiments by the same reference numerals and omitting descriptions thereof.

In the third embodiment, a seal groove 81 is formed over the entire circumference on the side surface (the axial side surface) of the flange portion 43C of the stator core main body 43 that faces the exterior member 37. The second seal member 72 is attached in the seal groove 81. The second seal member 72 fluid-tightly seals (sealingly separates) between the exterior member 37 of the molded coil 34 and the flange portion 43C of the stator core main body 43. Due to this provision, moisture such as rainwater and mud water is prevented from entering to the coil 36 and bobbin 35 side via between the stator core 42 and the molded coil 34.

Now, the second seal member 72 is a face seal that seals between the side surface of the stator core 42 (the flange portion 43C of the stator core main body 43) (the bottom surface of the seal groove 81) and the side surface of the exterior member 37 (between flat surfaces). The second seal member 72 seals between the exterior member 37 and the stator core main body 43 while pressing the exterior member 37 toward the bottom portion 53B of the cover member 53 based on a tightening margin between the “axial thickness of the second seal member 72 itself” and the “space between the bottom surface of the seal groove 81 of the stator core 42 and the side surface of the exterior member 37”. In other words, the exterior member 37 is disposed while being pressed toward the bottom portion 53B of the cover member 53 by the second seal member 72. Further, the second seal member 72 is attached in the seal groove 81 of the stator core main body 43, and the exterior member 37 is provided between the second seal member 72 and the bobbin 35 by that.

In this manner, the solenoid 33 according to the third embodiment includes the bobbin 35, the exterior member 37, the first seal member 71, and the second seal member 72. The second seal member 72 is contained in the seal groove 81 provided on the stator core main body 43 serving as the magnetic circuit member. The second seal member 72 is a face seal disposed between the bottom surface of the seal groove 81 and the side surface of the exterior member 37 and sealing these surfaces (the flat surfaces). The second seam 62, which corresponds to an interface between the bobbin 35 and the exterior member 37, is located on the deeper side than the portion sealed by the second seal member 72, i.e., the downstream side in the direction in which the moisture enters. Due to this layout, the second seam 62 is disposed at a position where it is prevented from being immersed in the water with the aid of the second seal member 72.

On the other hand, the first seal member 71 is contained in the step 73 provided on the radially inner side of the exterior member 37 similarly to the second embodiment. Due to this configuration, in the third embodiment, the two seams (interfaces), the first seam 61 and the second seam 62 are also provided on the inner side with respect to the first seal member 71 and the second seal member 72, and therefore the two seams 61 and 62 can also be prevented from being immersed in the water, similarly to the second embodiment. Further, the first seal member 71 is a shaft seal and the second seal member 72 is a face seal, and therefore the exterior member 37 is pressed against the one axial end side where the bottom portion 53B of the cover member 53 serving as the magnetic circuit member is located. Therefore, the tightening margin of the second seal member 72 is uniquely determined.

The third embodiment is configured to achieve sealing using the first seal member 71 and the second seal member 72 as described above, and basic functions thereof are not especially different from the above-described functions according to the second embodiment. That is, the third embodiment can also improve the sealing performance for the seam between the bobbin 35 and the exterior member 37, similarly to the first embodiment and the second embodiment.

In the first embodiment, the cover member 53 has been described citing the example in which the tubular portion 53A and the bottom portion 53B of the cover member 53 are integrally formed. However, without being limited thereto, for example, the tubular portion of the cover member (the third member) and the bottom portion of the cover member (the first member) may be configured as different members. In other words, the first member, which is disposed on the one axial end side of the exterior member, and the third member, which covers the radially outer peripheral side of the exterior member, may be provided as different components from each other. The same also applies to the cover member in the case of the second embodiment and the third embodiment.

In the first embodiment, the cover member 53 has been described citing the example in which the cover member 53 is formed by one member. However, without being limited thereto, the cover member may be formed by, for example, two or more members by being divided circumferentially. Further, the cover member may be formed by, for example, two members, an inner cover member (a first cover member) and an outer cover member (a second cover member) that covers this inner cover member from outside. The same also applies to the cover member in the case of the second embodiment and the third embodiment.

In the first embodiment, the housing member 50 has been described citing the example in which the housing member 50 is configured to include the cap member 52 that is the bottomed tubular member. However, without being limited thereto, the housing member may be, for example, configured to include a tubular member opened on both the axial ends thereof. The same also applies to the housing member in the case of the second embodiment and the third embodiment.

In the first embodiment, the housing member 50 has been described citing the example in which the housing member 50 is formed by two members, the ring member 51 and the cap member 52. However, without being limited thereto, the housing member may be formed by, for example, one tubular member or one bottomed tubular member. The same also applies to the housing member in the case of the second embodiment and the third embodiment.

In the first embodiment, the stator core 42 has been described citing the example in which the stator core 42 is formed by the stator core main body 43 and the anchor member 44 (the fixed iron core). However, without being limited thereto, the stator core may be formed by a stator core main body integrated with the anchor member (the fixed iron core) and a cover member attached to this stator core main body. The same also applies to the stator core in the case of the second embodiment and the third embodiment.

In the first embodiment, the solenoid 33 has been described citing the example in which the solenoid 33 is configured in such a manner that the outer peripheral surface of the second seal member 65 faces the inner peripheral surface of the exterior member 37, and the inner peripheral surface of the second seal member 65 faces the outer peripheral surface of the tubular portion 43A (the large-diameter tubular portion 43A2) of the stator core main body 43. However, without being limited thereto, the solenoid may be configured in such a manner that the housing member extends to the second member side, and the outer peripheral surface of the housing member and the inner peripheral surface of the second seal member face each other.

In the first embodiment, the solenoid 33 has been described citing the example in which the solenoid 33 is configured in such a manner that the step 63 is formed at the second seam 62. However, without being limited thereto, a step may be formed at, for example, the first seam. In this case, the solenoid can be configured in such a manner that a step is formed at any one of the first seam and the second seam. The same also applies to the solenoid in the case of the second embodiment and the third embodiment.

In the first embodiment, the housing member 50 has been described citing the example in which the entire portion of the housing member 50 in contact with the thin-walled portion 43G of the stator core 42. i.e., the ring member 51 is made of a nonmagnetic body. However, without being limited thereto, the housing member may be configured in such a manner that at least a part of the portion thereof in contact with the thin-walled portion of the stator core is made of a nonmagnetic body by, for example, setting a smaller (shorter) axial dimension of the ring member than the dimension of the thin-walled portion. The same also applies to the housing member in the case of the second embodiment and the third embodiment.

In the first embodiment, the housing member 50 has been described citing the example in which the housing member 50 is formed by the ring member 51, which is a nonmagnetic annular member that allows the entire portion in contact with the thin-walled portion 43G of the stator core 42 to become a nonmagnetic body, and the cap member 52, which is a ferromagnetic annular member that allows the opposite end side with respect to this contact portion to become a ferromagnetic body. However, without being limited thereto, the housing member may be configured in such a manner that the nonmagnetic annular member allows the portion in contact with the thin-walled portion of the stator core and one end side with respect to this contact portion to become a nonmagnetic body by, for example, increasing (elongating) the axial dimension of the ring member to the one end side compared to the thin-walled portion. The same also applies to the housing member in the case of the second embodiment and the third embodiment.

In the first embodiment, the cover member 53 has been described citing the example in which the cover member 53 is made of a yoke (a magnetic body). However, without being limited thereto, for example, the solenoid may be configured as a coil-exposed solenoid including no yoke by making the cover member of a nonmagnetic body. The same also applies to the cover member in the case of the second embodiment and the third embodiment.

In the first embodiment, the solenoid 33 has been described citing the example in which the solenoid 33 is configured as a proportional solenoid. However, without being limited thereto, the solenoid may be configured as, for example, an ON/OFF solenoid. The same also applies to the solenoid in the case of the second embodiment and the third embodiment.

In each of the embodiments, the solenoid 33 has been described citing the example in which the solenoid 33 is used as the damping force variable actuator of the hydraulic shock absorber 1, i.e., the pilot valve member 32 forming the pilot valve of the damping force adjustment valve 18 is set as the driving target. However, without being limited thereto, the solenoid can be widely used as an actuator built in various kinds of mechanical apparatuses such as a valve used for a hydraulic circuit, i.e., a driving apparatus that drives a driving target that should be linearly driven. Further, each of the above-described embodiments is merely an example, and it is apparent that the configurations indicated in the different embodiments can be partially replaced or combined.

Possible configurations as the solenoid based on the above-described embodiments include the following examples.

As a first configuration, a solenoid includes a coil wound around a bobbin and configured to generate a magnetic force in reaction to power supply, an exterior member covering the coil and the bobbin therewith, a movable element disposed on an inner peripheral side of the coil and provided axially movably, a housing member housing the movable element therein, a stator configured to attract the movable element, a control valve configured to be controlled according to a movement of the movable element, a first member disposed on one axial end side of the exterior member, a second member located on an opposite axial end side where an opposite axial end of the exterior member is located and the control valve is disposed, and a third member covering a radially outer peripheral side of the exterior member therewith. A first seam and a second seam are provided between the bobbin and the exterior member. A first seal member is disposed on an upstream side of the first seam and between the first member and the exterior member. A second seal member is disposed on an upstream side of the second seam and between the second member and the exterior member.

According to this first configuration, the first seal member is disposed on the upstream side of the first seam (i.e., an upstream side in a direction in which water enters from outside) between the first member and the exterior member. On the other hand, the second seal member is disposed on the upstream side of the second seam (i.e., the upstream side in the direction in which the water enters from outside) between the second member and the exterior member. Therefore, the first seam between the bobbin and the exterior member can be sealed by the first seal member, and the second seam between the bobbin and the exterior member can be sealed by the second seal member. As a result, the sealing performance can be improved for the first seam and the second seam between the bobbin and the exterior member.

As a second configuration, in the first configuration, the first seal member is a face seal and the second seal member is a shaft seal. According to this second configuration, the first seal member can seal between the outer surface of the exterior member and the inner surface of the first member. Further, the second seal member can seal between the inner peripheral surface of the exterior member and the outer peripheral surface of the second member or the housing member. More specifically, the first seal member can seal between the outer surface of the exterior member and the inner surface of the first member while pressing the exterior member toward the second member based on the tightening margin between the “axial thickness of the first seal itself” and the “space of the portion in which the first seal member is disposed between the outer surface of the exterior member and the inner surface of the first member”. Further, the second seal member can seal between the inner peripheral surface of the exterior member and the outer peripheral surface of the second member or the housing member based on the tightening margin between the “radial thickness of the second seal member itself” and the “space of the portion in which the second seal member is disposed between the inner peripheral surface of the exterior member and the outer peripheral surface of the second member or the housing member”. In this case, the first seal member and the second seal member can have different specifications (the direction of the surface to seal), and therefore can, for example, secure the sealing performance while absorbing a linear expansion difference when the temperature increases. Further, the productivity can also be improved. As used herein, the “face seal” refers to a seal member disposed between end surfaces of two members having flow passages (holes) of fluid and sealing a space between these two members. Further, the “shaft seal” refers to a seal member disposed between the outer peripheral surface of a housing member and the inner peripheral surface of a member surrounding this housing member (the bobbin, the exterior member, or the second member) and sealing a space between the housing member and the member surrounding this housing member.

As a third configuration, in the first configuration, the first seal member is a shaft seal and the second seal member is a face seal. According to this third configuration, the first seal member can seal between the inner peripheral surface of the exterior member and the outer peripheral surface of the first member or the housing member. Further, the second seal member can seal between the outer surface of the exterior member and the inner surface of the second member. More specifically, the first seal member can seal between the inner peripheral surface of the exterior member and the outer peripheral surface of the first member or the housing member based on the tightening margin between the “radial thickness of the first seal member itself” and the “space of the portion in which the first seal member is disposed between the inner peripheral surface of the exterior member and the outer peripheral surface of the first member or the housing member”. Further, the second seal member can seal between the outer surface of the exterior member and the inner surface of the second member while pressing the exterior member toward the first member based on the tightening margin between the “axial thickness of the second seal itself” and the “space of the portion in which the second seal member is disposed between the outer surface of the exterior member and the inner surface of the second member”. In this case, the first seal member and the second seal member can have different specifications (the direction of the surface to seal), and therefore can, for example, secure the sealing performance while absorbing a linear expansion difference when the temperature increases.

As a fourth configuration, in the second configuration, the second seal member is disposed among the housing member, the bobbin surrounding the housing member, the exterior member, and the second member. According to this fourth configuration, the solenoid can seal among the housing member, the bobbin, the exterior member, and the second member using the second seal member, which is the shaft seal.

As a fifth configuration, in the second configuration, the exterior member is disposed while being pressed toward the second member by the first seal member. According to this fifth configuration, with the aid of the first seal member, which is the face seal, the solenoid can seal between the outer surface of the exterior member and the inner surface of the first member while pressing the exterior member toward the second member corresponding to the direction away from the first member based on the tightening margin between the “axial thickness of the first seal itself” and the “space of the portion in which the first seal member is disposed between the outer surface of the exterior member and the inner surface of the first member”. In this case, the solenoid can suppress direct transmission of vibration (PWM noise) from the outer surface of the exterior member to the inner surface of the first member with the aid of the first seal member, thereby suppressing an outward leak of this vibration (noise). In other words, since the exterior member is not pressed outward (to the first member side and the third member side) but is pressed inward (to the second member side), the solenoid can impede an outward leak of PWM noise.

As a sixth configuration, in any of the first configuration to the fifth configuration, a step is formed between the bobbin and the exterior member at any one of the first seam or the second seam. According to this sixth configuration, the step at any one of the first seam or the second seam can be positioned at the contact position between a mold (a base) used when the coil and the bobbin are covered with the exterior member by molding, and the bobbin. In sum, the bobbin can be positioned in the mold when being subjected to the molding based on the step.

As a seventh configuration, in any of the first configuration to the sixth configuration, the exterior member is provided between the first seal member and the bobbin. According to this seventh configuration, the exterior member can be poured as far as the first seam when the coil and the bobbin are covered with the exterior member by the molding.

As an eighth configuration, in any of the first configuration to the seventh configuration, all of the first, second, and third members are made from magnetic materials. According to this eighth configuration, a magnetic circuit (a magnetic path) can be formed by the first, second, and third members.

As a ninth configuration, a damping force adjustment mechanism includes a coil wound around a bobbin and configured to generate a magnetic force in reaction to power supply, an exterior member covering the coil and the bobbin therewith, a movable element disposed on an inner peripheral side of the coil and provided axially movably, a housing member housing the movable element therein, a stator configured to attract the movable element, a control valve configured to be controlled according to a movement of the movable element, a first member disposed on one axial end side of the exterior member, a second member located on an opposite axial end side where an opposite axial end of the exterior member is located and the control valve is disposed, and a third member covering a radially outer peripheral side of the exterior member therewith. A first seam and a second seam are provided between the bobbin and the exterior member. A first seal member is disposed on an upstream side of the first seam and between the first member and the exterior member. A second seal member is disposed on an upstream side of the second seam and between the second member and the exterior member. According to this ninth configuration, the sealing performance can be improved for the first seam and the second seam between the bobbin and the exterior member.

As a tenth configuration, a damping force adjustable shock absorber includes a cylinder sealingly containing hydraulic fluid therein, a piston provided slidably in the cylinder, a piston rod coupled with the piston and extending out of the cylinder, and a damping force adjustment mechanism configured to generate a damping force by controlling a flow of the hydraulic fluid that is generated according to a sliding movement of the piston in the cylinder. The damping force adjustment mechanism includes a coil wound around a bobbin and configured to generate a magnetic force in reaction to power supply, an exterior member covering the coil and the bobbin therewith, a movable element disposed on an inner peripheral side of the coil and provided axially movably, a housing member housing the movable element therein, a stator configured to attract the movable element, a control valve configured to be controlled according to a movement of the movable element, a first member disposed on one axial end side of the exterior member, a second member located on an opposite axial end side where an opposite axial end of the exterior member is located and the control valve is disposed, and a third member covering a radially outer peripheral side of the exterior member therewith. A first seam and a second seam are provided between the bobbin and the exterior member. A first seal member is disposed on an upstream side of the first seam and between the first member and the exterior member. A second seal member is disposed on an upstream side of the second seam and between the second member and the exterior member. According to this tenth configuration, the sealing performance can be improved for the first seam and the second seam between the bobbin and the exterior member.

The present invention shall not be limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2019-224682 filed on Dec. 12, 2019. The entire disclosure of Japanese Patent Application No. 2019-224682 filed on Dec. 12, 2019 including the specification, the claims, the drawings, and the abstract is incorporated herein by reference in its entirety.

### REFERENCE SIGNS LIST

1 hydraulic shock absorber (damping force adjustable shock absorber)
17 damping force adjustment apparatus (damping force adjustment mechanism)
32 pilot valve member (control valve)
33 solenoid
34 molded coil
35 bobbin
36 coil
37 exterior member
42 stator core
43 stator core main body (second member)
44 anchor member (stator)
48 movable iron core (movable element)
50 housing member
53 cover member (first member and third member)
61 first seam
62 second seam
67, 73 step
64, 71 first seal member
65, 72 second seal member
66, 74, 81 seal groove

1. A solenoid comprising:
a coil wound around a bobbin and configured to generate a magnetic force in reaction to power supply;
an exterior member covering the coil and the bobbin therewith;
a movable element disposed on an inner peripheral side of the coil and provided axially movably;
a housing member housing the movable element therein;
a stator configured to attract the movable element;
a first member disposed on one axial end side of the exterior member;
a second member located on an opposite axial end side where an opposite axial end of the exterior member is located and the stator is disposed; and
a third member covering a radially outer peripheral side of the exterior member therewith,
wherein a first seam and a second seam are provided between the bobbin and the exterior member,
wherein a first seal member is disposed on an upstream side of the first seam and an upstream side in the direction in which water enters the interior from outside and between the first member and the exterior member, and
wherein a second seal member is disposed on an upstream side of the second seam and the upstream side in the direction in which water enters the interior from outside and between the second member and the exterior member.

2. The solenoid according to claim 1, wherein the first seal member is a face seal and the second seal member is a shaft seal.

3. The solenoid according to claim 1, wherein the first seal member is a shaft seal and the second seal member is a face seal.

4. The solenoid according to claim 2, wherein the second seal member is disposed among the housing member, the bobbin surrounding the housing member, the exterior member, and the second member.

5. The solenoid according to claim 2, wherein the exterior member is disposed while being pressed toward the second member by the first seal member.

6. The solenoid according to claim 1, wherein a step is formed between the bobbin and the exterior member at any one of the first seam or the second seam.

7. The solenoid according to claim 1, wherein the exterior member is provided between the first seal member and the bobbin.

8. The solenoid according to claim 1, wherein all of the first, second, and third members are made from magnetic materials.

9. A damping force adjustment mechanism comprising:
a coil wound around a bobbin and configured to generate a magnetic force in reaction to power supply;
an exterior member covering the coil and the bobbin therewith;
a movable element disposed on an inner peripheral side of the coil and provided axially movably;
a housing member housing the movable element therein;
a stator configured to attract the movable element;
a control valve configured to be controlled according to a movement of the movable element;
a first member disposed on one axial end side of the exterior member;
a second member located on an opposite axial end side where an opposite axial end of the exterior member is located and the control valve is disposed; and
a third member covering a radially outer peripheral side of the exterior member therewith,
wherein a first seam and a second seam are provided between the bobbin and the exterior member,
wherein a first seal member is disposed on an upstream side of the first seam and an upstream side in the direction in which water enters the interior from outside and between the first member and the exterior member, and
wherein a second seal member is disposed on an upstream side of the second seam and an upstream side in the direction in which water enters the interior from outside and between the second member and the exterior member.

10. A damping force adjustable shock absorber comprising:
a cylinder sealingly containing hydraulic fluid therein;
a piston provided slidably in the cylinder;
a piston rod coupled with the piston and extending out of the cylinder; and
a damping force adjustment mechanism configured to generate a damping force by controlling a flow of the hydraulic fluid that is generated according to a sliding movement of the piston in the cylinder,
wherein the damping force adjustment mechanism includes
a coil wound around a bobbin and configured to generate a magnetic force in reaction to power supply,
an exterior member covering the coil and the bobbin therewith,
a movable element disposed on an inner peripheral side of the coil and provided axially movably,
a housing member housing the movable element therein,
a stator configured to attract the movable element,
a control valve configured to be controlled according to a movement of the movable element,
a first member disposed on one axial end side of the exterior member,
a second member located on an opposite axial end side where an opposite axial end of the exterior member is located and the control valve is disposed, and
a third member covering a radially outer peripheral side of the exterior member therewith,
wherein a first seam and a second seam are provided between the bobbin and the exterior member,
wherein a first seal member is disposed on an upstream side of the first seam and an upstream side in the direction in which water enters the interior from outside and between the first member and the exterior member, and
wherein a second seal member is disposed on an upstream side of the second seam and an upstream side in the direction in which water enters the interior from outside and between the second member and the exterior member.
